(19) United States
(12) Patent Application Publication
(10) Pub. No.: US 2012/0228850 A1
(43) Pub. Date: Sep. 13, 2012

(54) REAR SUSPENSION SYSTEM FOR BICYCLES

(75) Inventor: JIMMY TSENG, TAICHUNG CITY (TW)

(73) Assignee: KINESIS INDUSTRY CO., LTD., TAICHUNG CITY (TW)

(21) Appl. No.: 13/044,828

(22) Filed: Mar. 10, 2011

(51) Int. Cl. B62K 19/36; B62K 19/30

(52) U.S. Cl. 280/283

(57) ABSTRACT

A rear suspension system for a bicycle which includes a front part having a top tube, a down tube and a seat bracket, and a rear part has seat stays and chain stays. The seat tube has a frame located close to the bottom bracket. A top link unit is pivotably connected to the seat stays and extends toward the front part to form a first pivotal portion. The chain stays are connected to a down link unit which extends into the frame. A second pivotal portion is formed at the mediate portion of the down link unit. A shock-absorbing device has its top end pivotably connected to the first pivotal portion and the lower end of the shock-absorbing device extends into the frame and is pivotably connected to the second pivotal portion which is located close to the axis of the seat tube to provide stable buffering action.

### FIELD OF THE INVENTION

The present invention relates to a rear suspension system, and more particularly, to a rear suspension system for bicycles and which reduces impact to the seat tube.

### BACKGROUND OF THE INVENTION

A conventional rear suspension system is mainly used on mountain bikes and the rear suspension system buffers the impact to the bicycle frame from the ground so as to increase comfort to the cyclists. The conventional rear suspension system generally includes the seat stays, the chain stays and the shock-absorbing device.

The design to the rear suspension system has to consider multiple factors including the position, the angle, the efficiency of the shock-absorbing feature, the buffering actions, the stiffness of the bicycle frame and the connection parts. Therefore, there are many different types of rear suspension systems.

A conventional rear suspension system is disclosed in Taiwan Utility Patent No. 087219571 and the bicycle frame includes a front part and a rear part. The front part is connected with the front wheel, the handlebar and the pedals. The rear part is connected with the rear wheel. A shock-absorbing device is connected between the front and rear part. The rear part includes a first axle pivotably connected to the front part, a fixing member connected to the rear wheel, a second axle connected between the front part and the fixing member, and a third axle connected between the first axle and the fixing member. The two ends of the second and third axles are respectively connected to the fixing member, the first axle and four connection points on the front part. At least one of the four points has a connector which includes an adjustment portion and a pivotable portion. The pivotable portion has a hole and swings within a range of the connector to change the angle between the axis of the hole and the connector. The adjustment portion is movably connected to the second axle or the third axle so as to adjust the two respective distances between the hole and the second axle and the third axle.

Another conventional rear suspension system is disclosed in Taiwan Utility Patent Application No. 95203724 and includes a front part having a top tube, a seat tube and a bottom bracket, and a rear part having seat stays, chain stays and two drop-outs. The seat tube includes a top link unit pivotably connected to the mediate portion thereof and the top link unit includes a rear arm and a front arm which is shorter than the rear arm. The distal end of the rear arm is pivotably connected to the front end of the seat stays. The bottom bracket is pivotably the down link unit which has a back arm passing above the bottom bracket, and a connection arm which extends upward. The distal end of the back arm is pivotably connected to the front end of the chain stays and the pivotal point is located behind and below the bottom bracket. An upright shock-absorbing device is pivotably connected between the front arm of the top link unit and the connection arm of the down link unit. The connection point of the shock-absorbing device is lower than the connection point between the rear arm of the top link unit and the front end of the seat stays.

The first prior art is single-link rear suspension system and includes a two-section seat tube, and the chain stays are connected to the bottom bracket. The seat strays extend through the gap between the two sections of the seat tube and is pviotably connected to a link unit which is pivotably connected to the down tube. The shock-absorbing device is connected between the top tube and the link unit. The second prior art is dual link rear suspension system and includes the top link unit pivotably connected to the set tube. The two sides of the top link unit are respectively pivotably connected to the seat stays and the top of the shock-absorbing device. The down link unit is pivotably connected to a position close to the bottom bracket. The two sides of the down link unit are respectively pivotably connected to the chain stays and a position below the shock-absorbing device which is oriented upright.

For the dual link rear suspension system, the two ends of the shock-absorbing device are moved along with the movement of the top and down link units so as to restrict the angular movement of the shock-absorbing device within 2 degrees. This restriction can protect the shock-absorbing device.

However, the down link unit is pivotably connected to the front of the seat tube and located close to the bottom bracket, so that the impact that is applied to the rear part is transferred to the front of the seat tube, not the axis of the seat tube. Therefore, the center of weight tends to swing. Besides, the shock-absorbing device is located at a distance from the axis of the seat tube, and this cannot accept the impact to the seat tube, so that the efficiency for reducing the shock is low. The seat tube is a cylindrical and circular tube which directly transfers the impact to the cyclist's hip so that the cyclist easily feels discomfort.

The primary object of the invention is to provide a rear suspension system for bicycles and the seat has a non-tubular frame connected thereto which is shaped to spread vibrations transferred from the ground to increase the comfort to the cyclists.

Another object of the present invention is to provide a rear suspension system for bicycles wherein the down link unit is pivotably within the frame and located close to the axis of the seat tube so that the rear part of the bicycle frame is pivotable about the axis of the seat tube to maintain the stable status of the bicycle.

Yet another object of the present invention intends to provide a rear suspension system for bicycles wherein the shock-absorbing device is inserted into the frame and the lower end of the shock-absorbing device is pivotably connected to the axis of the seat tube so as to directly accept the force from transferred along the axis of the seat tube to have better efficiency.

A further object of the present invention is to provide a rear suspension system for bicycles wherein the down link unit comprises two substantially inverted V-shaped parts and the lower end of the shock-absorbing device is pivotably connected to the mediate portion of the front extensions of the two substantially inverted V-shaped parts so that when the rear part is pivoted, the angle that the front extensions pivot is less than that of the rear extensions to increase the sensibility of the shock-absorbing device.

### SUMMARY OF THE INVENTION

The present invention relates to a rear suspension system for bicycles and comprises a front part and a rear part, wherein the front part has a top tube, a down tube and a seat bracket, and the rear part has seat stays and chain stays. A lower end of the down tube is connected to the bottom bracket and a lower end of the seat tube has a substantially inverted U-shaped frame connected thereto which is located close to the bottom bracket. The frame extends upward from the bottom bracket and defines a space with the bottom bracket. The chain stays have first ends connected to first ends of the seat stays. A top link unit is connected to second ends of the seat stays. The top link unit is pivotably connected to a mediate portion of the seat tube and extends toward the front part to form a first pivotal portion. Two respective second ends of the chain stays are connected to a first end of a down link unit and a second end of the down link unit extends into the frame. A second pivotal portion is formed at the mediate portion of the down link unit. A shock-absorbing device has a top end pivotably connected to the first pivotal portion and a lower end of the shock-absorbing device extends into the frame and is pivotably connected to the second pivotal portion. The lower end of the down link unit and the lower end of the shock-absorbing device are both located close to the axis of the seat tube can maintain the stability of the bicycle when the shock-absorbing device is in operation.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the rear suspension system for bicycles of the present invention;

FIG. 2 is another perspective view to show the rear suspension system for bicycles of the present invention;

FIG. 3 is an exploded view to show the rear suspension system for bicycles of the present invention;

FIG. 4 is a side view of the rear suspension system for bicycles of the present invention;

FIG. 5 is a side view of the rear suspension system for bicycles of the present invention when in operation, and

FIG. 6 is an exploded view to show another embodiment of the rear suspension system for bicycles of the present invention.

### DETAILED DESCRIPTION OF THE PREFERRED EMBODIMENT

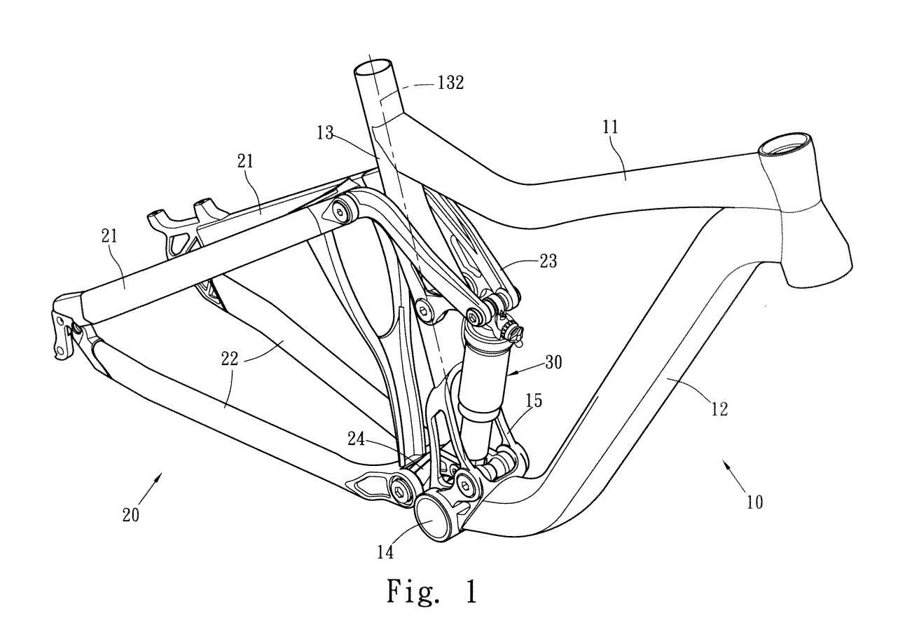

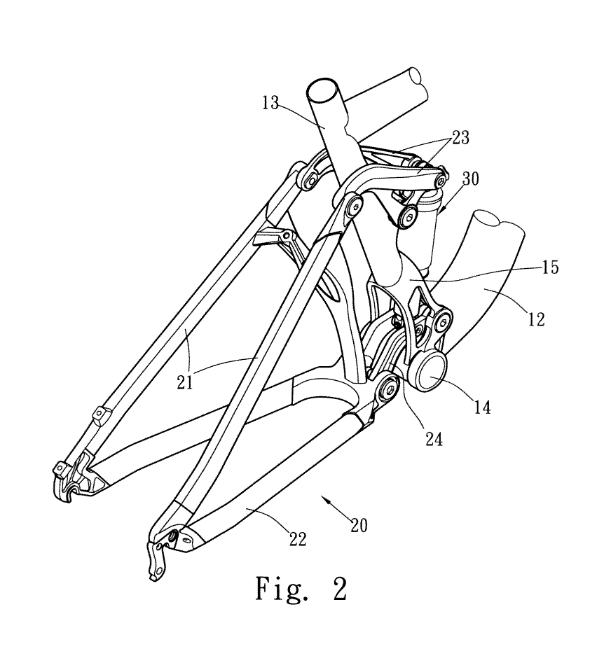

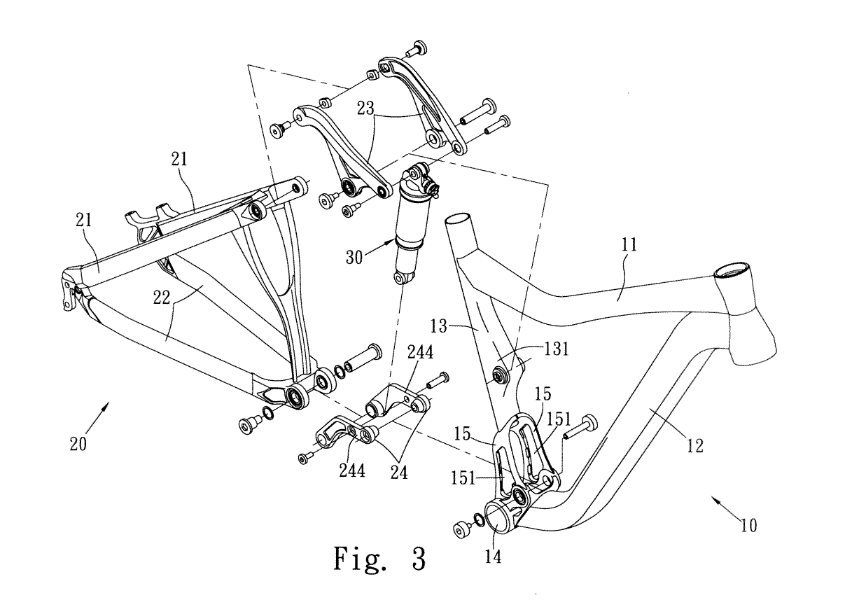

Referring to FIGS. 1 to 4, the rear suspension system for bicycles of the present invention comprises a front part 10, a rear part 20 and a shock-absorbing device 30 connected between the front part 10 and the rear part 20.

The front part 10 has a top tube 11, a down tube 12 and a seat bracket 13. The lower end of the down tube 12 is connected to the bottom bracket 14 and the lower end of the seat tube 13 has a substantially inverted U-shaped frame 15 connected thereto which is located close to the bottom bracket 14. The frame 15 extends upward from the bottom bracket 14 and defines a space with the bottom bracket 14. The mediate portion of the seat tube 13 has a protrusion 131 extending toward a direction opposite to the front part 10. Two sides of the substantially inverted U-shaped frame 15 each have an opening 151 communicating with the space in the frame 15.

The rear part 20 has seat stays 21 and chain stays 22. The chain stays 22 have two respective first ends connected to the two respective first ends of the seat stays 21.

A top link unit 23 is connected to the second ends of the seat stays 21 and pivotably connected to a mediate portion of the seat tube 13 and extends toward the front part 10 to form a first pivotal portion 233. In detail, the top link unit 23 is pivotably connected to the protrusion 131 and has a third pivotal portion 232, and a position of the first pivotal portion 233 is lower than a position of the third pivotal position 232 in horizontal direction. Two respective second ends of the chain stays 22 are connected to the first end of a down link unit 24 and the second end of the down link unit 24 extends into the frame 15. The second pivotal portion 243 is formed at the mediate portion of the down link unit 24.

The down link unit 24 is a substantially inverted V-shaped part which has a first end pivotably connected to the frame 15 to form a fourth pivotal portion 241 and the second end of the down link unit 24 is pivotably connected to the chain stays 22 to form a fifth pivotal portion 242. It is noted that where the seat stays 21 is pivotably connected to the top link unit 23 is at the sixth pivotal portion 231. The down link unit 24 is a substantially inverted V-shaped part and includes two symmetrical substantially inverted V-shaped bars which includes two front extensions 244 and two rear extensions 245. The second pivotal portion 243 is located at two respective mediate portions of two front extensions 244 of the down link unit 24, wherein the two front extensions 244 extend toward the down tube 12. The second pivotal portion 243 is located close to the fourth pivotal portion 241 and at a distance from the fifth pivotal portion 242. In other words, the second pivotal portion 243 is located close to an axis 132 of the seat tube 13.

The shock-absorbing device 30 has a top end pivotably connected to the first pivotal portion 233 and the lower end of the shock-absorbing device 30 extends into the frame 15 and is pivotably connected to the second pivotal portion 243.

The fourth pivotal portion 241 and the lower end of the shock-absorbing device 30 are located close to the axis 132 of the seat tube 13, and the lower end of the shock-absorbing device 30 is located within the space of the frame 15, the rear part 20 is stably pivoted and the impact and vibrations transferred to the seat tube 13 are reduced.

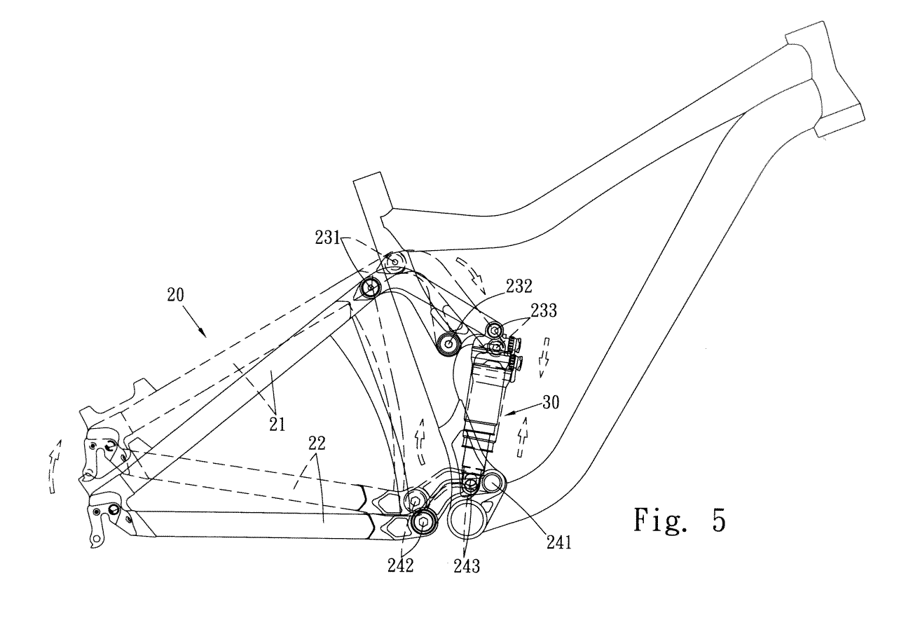

As shown in FIG. 5, when the shock-absorbing device 30 is in operation, the rear part 20 is reacted in two ways, one of which is that the chain stays 22 and the down link unit 24 are pivoted upward about the fourth pivotal portion 241, and the fifth pivotal portion 242 is pivoted. The shock-absorbing device 30 pivotably connected to the front extensions 244 is applied a force from the down link unit 24 and the lower end of the shock-absorbing device 30 is moved linearly upward. The second way is that the seat stays 21 move forward to pivot the top link unit 23. The first pivotal portion 233 is pivoted downward and the top end of the shock-absorbing device 30 moves linearly downward by the force from the top link unit 23. Therefore, the shock-absorbing device 30 is compressed.

When the shocks and impacts are disappeared, the shock-absorbing device 30 bounces back and the rear part 20 is reacted in two ways. One way is that the lower end of the shock-absorbing device 30 is moved linearly to push the front extensions 244 so that the down link unit 24 is pivoted about the fourth pivotal portion 241 and the chain stays 22 are pivoted back. The second way is that the top end of the shock-absorbing device 30 moves linearly to push the top link unit 23 back, and the chain stays 22 are pivoted back. Therefore, the shock-absorbing device 30 is returned to its initial status.

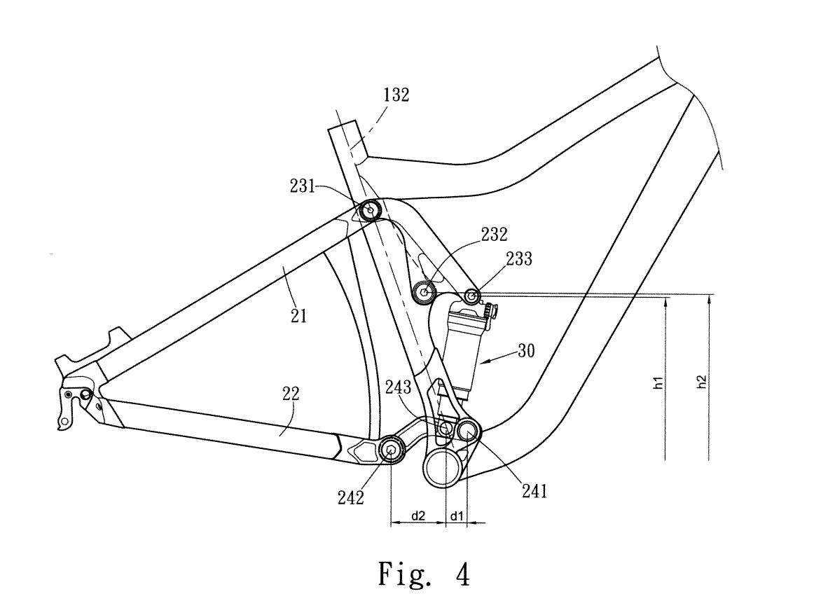

As shown in FIG. 4, the height h2 of the second pivotal portion 232 is higher than the height h1 of the first pivotal portion 233 in horizontal direction. This special arrangement makes the top link unit 23 to pivot a smaller angle to operate the shock-absorbing device 30. The lower that the top link unit 23 extends, the smaller angle it pivots and the more sensitive of the shock-absorbing device 30 is obtained. In other words, the size of the shock-absorbing device 30 is smaller and the weight of the bicycle is reduced.

The second pivotal portion 243 is connected with the lower end of the shock-absorbing device 30. The distance d1 is the distance between the fourth pivotal portion 241 and the second pivotal portion 243, and the distance d2 is the distance between the second pivotal portion 243 and the fifth pivotal portion 242. When the d2 is larger than d1, the small angular movement of the rear part 20 can activate the shock-absorbing device 30. In other words, the closer that the fourth pivotal portion 241 is located to the second pivotal portion 243, the quicker that the shock-absorbing device 30 is activated. Furthermore, the substantially inverted V-shaped down link unit 24 makes the angle that the front extensions 244 pivot is smaller than that of the rear extensions 245. Therefore, the lower end of the shock-absorbing device 30 is connected to the front extensions 244 increases the sensitivity of the reaction of the shock-absorbing device 30.

The lower end of the seat tube 13 is non-tubular and the frame 15 is integrally formed to the lower end of the seat tube 13 so that the vibrations or impacts are spread by the two sides of the frame 15. The complicated shaped of the frame 15 also reduces the vibrations and impacts to be transferred to the seat tube 13.

The conventional down link unit is affected by the size f the seat tube so that it cannot be located closer to the axis of the seat tube, so that the pivotable point is located at a distance from the seat tube and this makes the center of weight of the bicycle unstable. The space of the frame 15 of the present invention is located close to the axis 132 of the seat tube 13, the down link unit 24 is located in the frame 15 so that the down link unit 24 is located close to the axis 132 of the seat tube 13 and improves the shortcomings of the conventional suspension system.

The shock-absorbing device of the conventional suspension system is not located close to the axis of the seat tube, so that it cannot shock-absorbing device and can only accept the force from the pivotal action of the rear part. On the other hand, the lower end of the shock-absorbing device 30 is located in the frame 15 and pivotably connected to the down link unit 24, and the second pivotal portion 243 is located on the axis 132 of the seat tube 13, so that shock-absorbing device 30 accepts the force directly from the seat tube 13 along the axis 132. The shock-absorbing device 30 accepts the forces from the pivotal actions of the top and down link units 23, 24, it also accepts directly the force from the seat tube 13, so that the efficiency is high.

It is noted that the openings 151 in the two sides of the frame 15 reduces the weight of the frame 15 and is also convenient for assemblers to insert tools into the frame 15 to install the shock-absorbing device 30 and the down link unit 24.

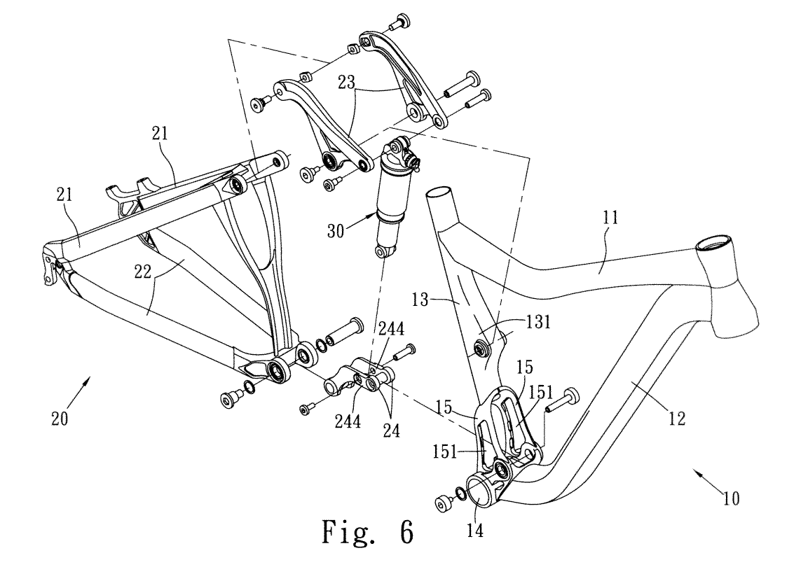

As shown in FIG. 6, another embodiment of the present invention is disclosed, wherein the two ends of the two inverted V-shaped bars are connected to each other so as to form a single frame.

While we have shown and described the embodiment in accordance with the present invention, it should be clear to those skilled in the art that further embodiments may be made without departing from the scope of the present invention.

What is claimed is:

1. A rear suspension system for bicycles, comprising:
a front part having a top tube, a down tube and a seat bracket, a lower end of the down tube connected to the bottom bracket and a lower end of the seat tube having a substantially inverted U-shaped frame connected thereto which is located close to the bottom bracket, the frame extending upward from the bottom bracket and defining a space with the bottom bracket;
a rear part having seat stays and chain stays, the chain stays having first ends connected to first ends of the seat stays, a top link unit connected to second ends of the seat stays, the top link unit pivotably connected to a mediate portion of the seat tube and extending toward the front part to form a first pivotal portion, two respective second ends of the chain stays connected to a first end of a down link unit, a second end of the down link unit extending into the frame, a second pivotal portion being formed at the mediate portion of the down link unit, and
a shock-absorbing device having a top end pivotably connected to the first pivotal portion and a lower end of the shock-absorbing device extending into the frame and pivotably connected to the second pivotal portion.

2. The system as claimed in claim 1, wherein the second pivotal portion is located close to an axis of the seat tube.

3. The system as claimed in claim 1, wherein two sides of the substantially inverted U-shaped frame each have an opening communicating with the space in the frame.

4. The system as claimed in claim 1, wherein the mediate portion of the seat tube has a protrusion extending toward a direction opposite to the front part, the top link unit is pivotably connected to the protrusion and has a third pivotal portion, a position of the first pivotal portion is lower than a position of the third pivotal position in horizontal direction.

5. The system as claimed in claim 1, wherein the down link unit is a substantially inverted V-shaped part which has a first end pivotably connected to the frame to form a fourth pivotal portion and a second end of the down link unit is pivotably connected to the chain stays to form a fifth pivotal portion, the second pivotal portion is located at two respective mediate portions of two front extensions of the down link unit, the two front extensions extend toward the down tube, the second pivotal portion is located close to the fourth pivotal portion and at a distance from the fifth pivotal portion.

6. The system as claimed in claim 1, wherein the down link unit is a substantially inverted V-shaped part and includes two symmetrical substantially inverted V-shaped bars.
